(19) United States
(12) Patent Application Publication
(10) Pub. No.: US 2025/0168005 A1
(43) Pub. Date: May 22, 2025

(54) SECURE NEAR-FIELD COMMUNICATION

(71) Applicant: Commissariat à l'Energie Atomique et aux Energies Alternatives, PARIS (FR)

(72) Inventor: Christine HENNEBERT, GRENOBLE (FR)

(21) Appl. No.: 18/945,709

(22) Filed: Nov. 13, 2024

(30) Foreign Application Priority Data
Nov. 22, 2023 (FR) 2312894

(51) Int. Cl. H04L 9/32; H04L 9/30

(52) U.S. Cl. CPC H04L 9/3226; H04L 9/3013; H04L 9/3066

(57) ABSTRACT

The present description concerns a method comprising: the generation, by a first device, of a first and of a second elements; the supplying of the first element, to a second device; the generation, by the second device, of a first public key; the supplying of the first public key to the first device; the generation, by the first device, of a session key; the generation, by the first device, of a first code, and its ciphering by the session key; the generation, by the first device, of a second public key; the supplying of the ciphered first code and of the second public key to the second device; the generation, by the second device, of the session key and the deciphering of the ciphered first code; the control of an actuator based on the first public key.

### FIELD

The present disclosure generally concerns methods of near-field communication between two devices, more particularly methods of key exchange by near-field communication.

### BACKGROUND

Some services, such as for example a locker rental, an overnight accommodation rental, the provision of secure parking for a vehicle such as a bicycle, etc., require an authentication between the service user and the equipment.

The authentication may be carried out via the execution of a client application, for example installed on a user's smartphone. However, in certain cases of use, it may be desirable for the execution of the application and/or the communication between the user's smartphone and the hardware device to take place in a white zone, that is, with no connection to any network.

Further, it may be desirable for the user to be able to authenticate to a plurality of hardware devices.

However, the authentication via a non-secure application is generally subject to cyberattacks such as, for example, replay attacks, spoofing attacks, relay attacks, or man-in-the-middle attacks.

There exists a need to improve methods of authentication between two devices. In particular, there exists a need to make authentication methods, carried out via a non-secure application, more robust against cyberattacks.

### SUMMARY

An embodiment provides a method of authentication between a first device and a second device, the method comprising:
the generation, by the first device, of a first element and of a second element, and their storage in a memory of the first device;
the supplying of the first element, via a user of the first device, to the second device;
the generation, by the second device, based on the first element and by application of a Diffie-Hellman protocol, of a first public key;
the supplying of the first public key to the first device and the storage of the first public key, in association with the first and second elements, into a memory of the first device;
the generation, by the first device, of a session key, based on the second element and on the first public key, by application of a Diffie-Hellman protocol on an elliptic curve;—the generation, by the first device, of a first code, based on the second element, and its ciphering by the session key;
the generation, by the first device, of a second public key;
the supplying, by a near-field communication, of the ciphered first code and of the second public key to the second device;
the generation, by the second device, of the session key, based on the first element and on the second public key, and the deciphering of the ciphered first code, by means of the session key;
the storage, into a memory of the second device, of the deciphered first code;
the control, by the second device, of a first actuator as a result of an authentication of the second device, or of a third device, by the first device and based on the first public key.

According to an embodiment, the above method further comprises:
the generation, by the first device, of a second code, based on the second element, and its ciphering with the session key and the provision, by near-field communication, of the ciphered second code to the second, or to the third, device;
the deciphering, by the second, or the third, device, of the second ciphered code and the comparison of the deciphered second code with the deciphered first code;
based on the comparison between the deciphered first and second codes, the control, by the second device or by the third device, of the first or of a second actuator.

According to an embodiment, the control of the first actuator causes an action of locking, or of unlocking, of the second device and the control of the second actuator causes an action of unlocking, or of locking, of the second, or of the third, device.

According to an embodiment, the first public key is supplied, by the second device, to the first device via a non-secure near-field communication.

According to an embodiment, the first element is a digital code and the supply of the first element to the second device, via the user consists of the entering, by the user, of the digital code on a keypad of the second device.

According to an embodiment, the first element is a quick response code and the supply of the first element to the second device, via the user consists of the presentation of the quick response code to a quick response code reader of the second device.

According to an embodiment, the second element is a random value comprising a number N of words comprised in a standard dictionary of entropy-coding words, for example the BitCoin improvement proposal 39 wordlist, N being an integer in the range from 3 to 24.

According to an embodiment, the session key is deleted from the first and second devices as a result of the execution of the first action, and the session key is generated again by the first device, and then by the second, or the third, device, as a result of the authentication of the second, or of the third, device by the first device.

According to an embodiment, the above method further comprises, before the generation, by the first device, of the session key, the authentication of the second device, by the first device and based on the first public key and based on a master key.

According to an embodiment, the above method further comprises, prior to the execution of the first action:
the ciphering, by the second device, of the first element, and the provision of the ciphered first element to the first device;
the deciphering, by the first device, of the first ciphered element and the comparison between the deciphered first element and the first element; and
if the deciphered first element and the first element do not match, the stopping of the method.

According to an embodiment, the above method further comprises, as a result of the generation of the first code, the supplying of a message authentication code to the second device.

According to an embodiment, the message authentication code is one of the coordinates, on the elliptic curve, of the session key.

According to an embodiment, the above method further comprises, as a result of the supply of the ciphered first and/or of the ciphered second code:
the estimating, by the second, or the third, device, of the time elapsed between the sending, by the first device, of the ciphered code and the reception, by the second device, of the ciphered code;
the comparison, by the second, or the third, device, of the estimated elapsed time with a threshold value; and
if the estimated elapsed time is greater than or equal to the threshold value, the stopping of the method.

According to an embodiment, the first code is a concatenation of a first part of a value generated based on the second element with a second part of the value and the second code is a concatenation of the first part of the value with a third part of the value.

An embodiment provides a system comprising a first and a second devices configured to carry out the above method.

According to an embodiment, the first device is a smartphone.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 illustrates an example of an authentication between at least one user and a bicycle terminal according to an embodiment of the present disclosure;

FIG. 2 illustrates a near-field communication between two devices;

FIG. 3A illustrates the emulation of a near-field communication by a device comprising a secure element;

FIG. 3B illustrates the emulation of a near-field communication by a device comprising an emulation card, according to an embodiment of the present disclosure;

FIG. 4 illustrates an example of a cyberattack on a wireless communication between two devices;

FIG. 5 is a block diagram illustrating a system configured to implement an authentication method, according to an embodiment of the present disclosure;

FIG. 6A is a flowchart illustrating steps of an authentication method, according to an embodiment of the present disclosure; and

FIG. 6B is a flowchart illustrating steps of an authentication method, according to an embodiment of the present disclosure.

### DETAILED DESCRIPTION OF THE PRESENT EMBODIMENTS

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, the key exchange protocols are not described in detail. In particular, Diffie-Hellman key exchange protocols, based on elliptic curve cryptography, are known to those skilled in the art and are not described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

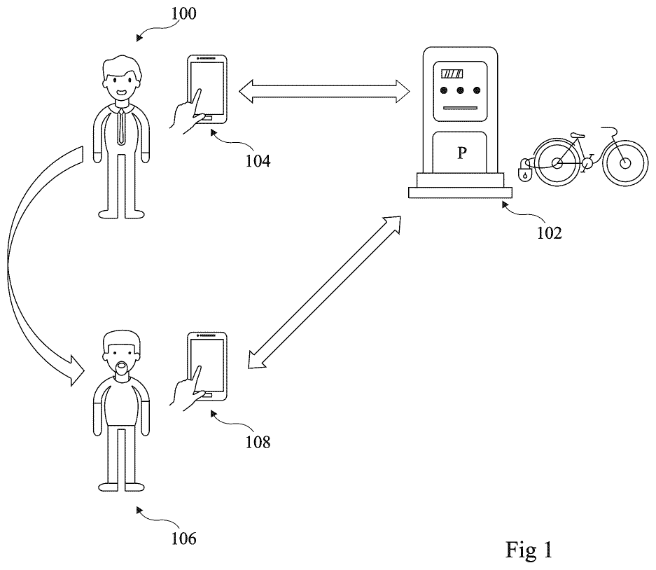

FIG. 1 illustrates an example of an authentication between at least one user 100 and a bicycle parking terminal 102 according to an embodiment of the present disclosure.

As an example, user 100 wishes to temporarily park his/her bicycle on terminal 102. The authentication between user 100 and terminal 102 for example enables to lock the bicycle in the terminal in order to protect it. Terminal 102 is, for example, configured to unlock the bicycle when user 100 wishes to retrieve it.

In particular, the authentication is performed via the use of a smartphone 104. As an example, smartphone 104 comprises a client application enabling user 100 to authenticate to terminal 102. Terminal 102 comprises, for example, an electronic card configured to perform cryptographic operations according to an embodiment of the present disclosure.

According to an embodiment, the communication between smartphone 104 and terminal 102 is wireless, and does not require for the smartphone to be connected to a network. As an example, the communication between smartphone 104 and terminal 102 is a near-field communication (NFC). As an example, terminal 102 comprises an NFC radio signal reader, configured to receive radio signals transmitted by smartphone 104.

According to an embodiment, once the bicycle has been locked in terminal 102, user 100 has the ability to enable another user 106 to retrieve the bicycle, and thus to order the unlocking of the bicycle. As an example, the unlocking of the bicycle by the other user 106 is performed via a smartphone 108, on which the client application is installed.

According to an embodiment, each authentication between user 100 and terminal 102 is unique. In other words, when user 100 has, for example, picked up his/her bicycle, the performed authentication is forgotten, by terminal 102 and by smartphone 104. Thus, each new re-authentication between user 100 and terminal 102 is carried out as if no authentication had ever taken place.

According to an embodiment, user 100 has the possibility of authenticating, for example simultaneously, to a plurality of terminals similar to terminal 102. Similarly, users other than user 100 have the possibility of authenticating to terminal 102, when it is free.

Although the example illustrated in FIG. 1 shows a bicycle terminal, other devices may of course be envisaged. As an example, in the same lock/unlock context, the device to which the user authenticates is, for example, a locker for storing belongings in a public place such as a swimming pool, a museum, a supermarket, etc.

In another example, the authentication is performed to a parking terminal, for example for self-service vehicles such as bicycles, scooters, or cars. In this example, the authentication enables for example to unlock a parked vehicle and then to lock it, for example at a parking terminal different from that used for the unlocking.

In still another example, the authentication takes place, for example, between two smartphones. In this example, the authentication is performed, for example, at the entrance of a museum or of a tourist attraction. As an example, the user authenticates at the entrance, then at the exit. As an example, the authentication at the entrance, and then at the exit, enables to achieve a time-based billing.

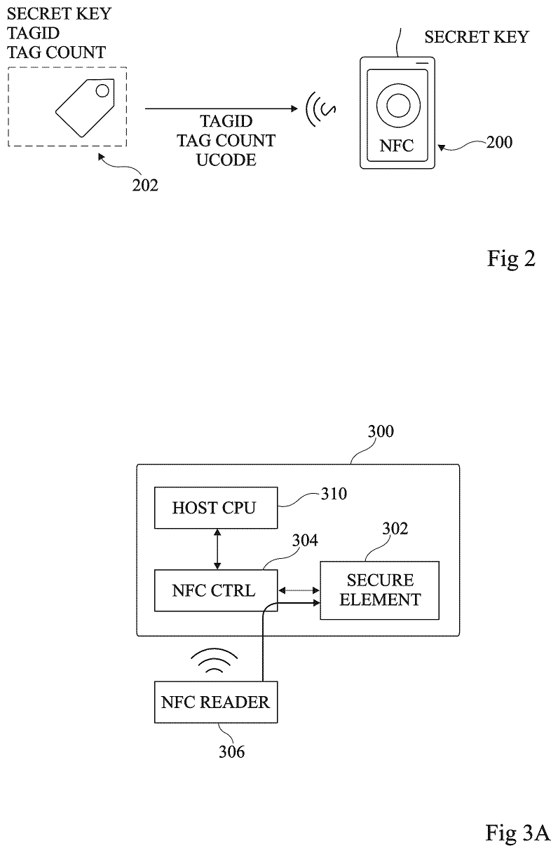

FIG. 2 illustrates a near-field communication protocol between two devices 200 and 202. In particular, FIG. 2 illustrates the verification, by a reader device 200, of the authenticity of an NFC tag transmitted by an electronic chip 202.

As an example, reader 200 is powered and transmits a radio signal. When electronic chip 202 is within range of the radio signal transmitted by reader 200, chip 202 is for example powered by the radio signal.

Electronic chip 202 is configured to deliver a message to reader 200. AS an example, the message comprises an identifier (TAGID), a count value (TAGCOUNT), and a ciphered code (UCODE). As an example, the ciphered code depends on the value of the identifier and on the count value. As an example, the ciphered code has been ciphered via a secret key (SECRETKEY) known to chip 202. Reader 200 is then configured to verify the authenticity of chip 200 based on the secret key, before executing, or not, the required action. As an example, the secret key is stored remotely, on a server, and chip 202 is configured to interrogate the server on receipt of the message, for example by supplying the server with the identifier, so that the server can supply it with the secret key.

However, this communication protocol is vulnerable to cyberattacks, such as for example relay or man-in-the-middle attacks. Further, this protocol requires a complex secret key management. In particular, in order for the secret key not to be transmitted during the NFC communication to reader 200, the secret key management for example relies on a public key infrastructure (PKI). The secret keys are then stored in a remote and secure server, for example in association with the chip identifier. The communication protocol requires a connection between the reader and the server having the secret keys stored therein. Reader 202 transmits to the remote server the ciphered message, the identifier, and the count value. The server, knowing the secret key of chip 200, is capable of verifying whether the ciphered message has effectively been generated based on the secret key of the indicated identifier, taking into account the count value. The incrementation of the count value for each new use of chip 200 prevents replay attacks on the ciphered message.

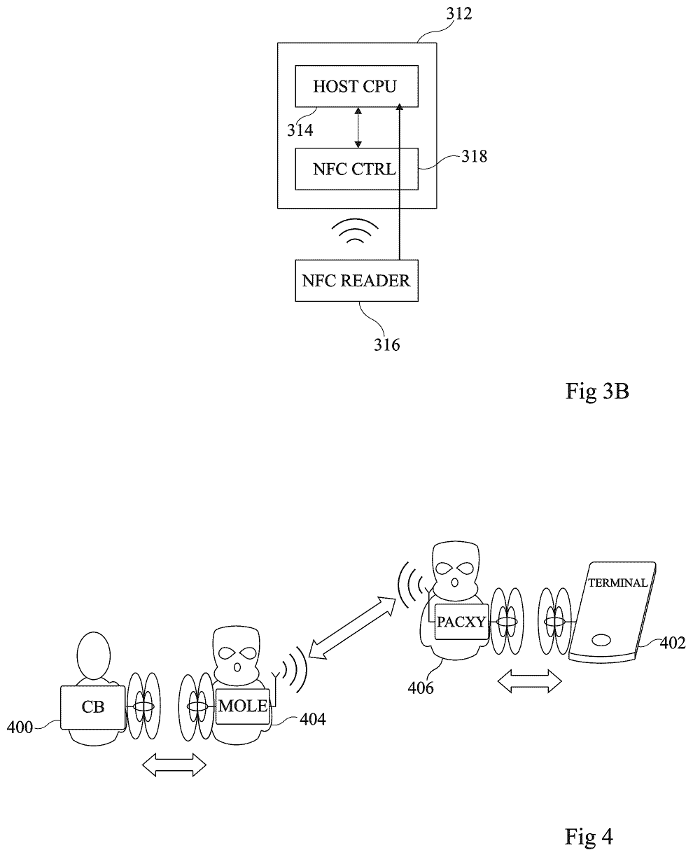

FIG. 3A illustrates the emulation of a near-field communication by a device 300 comprising a secure element 302 (SECURE ELEMENT). As an example, device 300 is a smartphone. As an example, secure element 302 comprises an emulation of a chip similar to chip 202. Device 300 further comprises a control circuit 304 (NFC CTRL) configured to supply data transmitted by a reader device 306 to secure circuit 302. Secure element 302 is configured to directly communicate with reader 306, without the intervention of a generic processor 310 (HOST CPU) of device 300. In particular, the near-field communication between secure element 302 and reader 306 takes place without involving the execution of an application installed on device 300. As an example, once the transaction between secure element 302 and reader 306 has been completed, processor 310 has access to the status of the transaction.

In the example described in relation with FIG. 3A, an application, such as the client application described in relation with FIG. 1, of device 300 does not have the possibility of initiating an NFC communication via secure element 302. Indeed, the access to secure element 302 is generally not open to applications. The client application thus cannot benefit from the advantages provided by secure element 302. In particular, the client application cannot benefit from the robustness of secure element 302 against cyberattacks during NFC communications.

FIG. 3B illustrates the emulation of a near-field communication by a device 312 comprising an NFC emulation software brick.

As an example, software enabling to emulate an NFC chip is installed in a memory (not shown) of device 312. As an example, the emulation software is a product of the HCE (Host Card Emulation) technology. As an example, the software is executed by a generic processor 314 (HOST CPU) of device 312 during an NFC transaction with a reader device 316 (NFC READER). As an example, device 312 further comprises a control circuit 318 (NFC CTRL) configured to deliver data transmitted from reader device 316 to processor 314, and/or to transmit data from processor 314 to control circuit 318.

HCE-type emulation software is easily implementable on a device such as a smartphone, and allows the use of applications using NFC communication protocols. However, the use of emulation software makes the device vulnerable to cyberattacks.

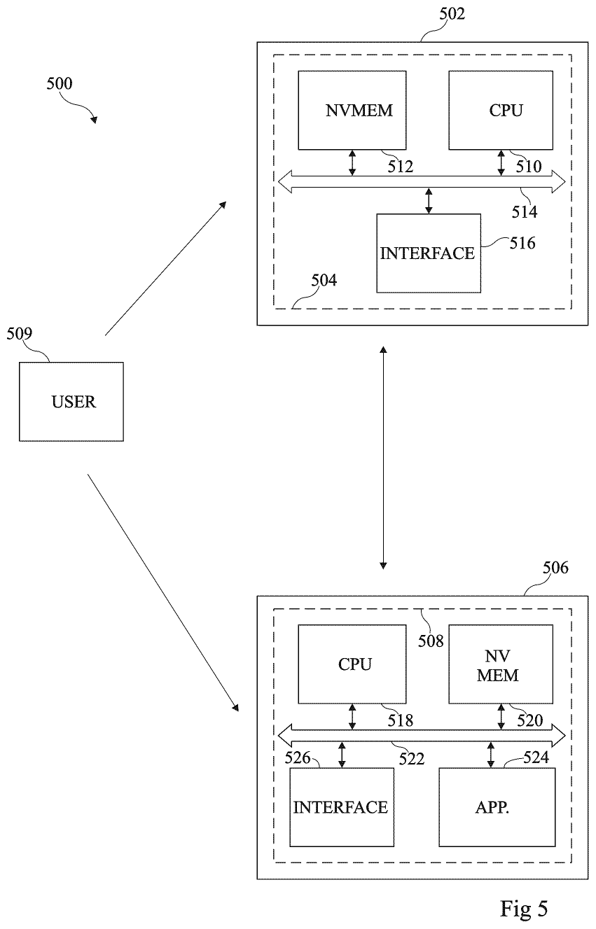

FIG. 4 illustrates an example of a cyberattack on a wireless communication between two devices 400 (CB) and 402 (TERMINAL). In particular, FIG. 4 illustrates a relay attack on device 400. Device 400 comprises, for example, an NFC chip. As an example, device 400 is a means of payment, such as a bank card or a smartphone comprising a payment application. As an example, device 402 is an electronic payment terminal (TPE) configured to perform financial transactions.

A relay attack on device 400 is for example carried out by two attackers and via a mole device 404 (MOLE) and a proxy device 406 (PROXY). Reader device 404 is placed close to device 400, for example at a distance shorter than 50 cm from device 400. The NFC chip of device 400 is then powered by the sending of a request by device 404. When device 400 answers the request, the message transmitted by device 400 is transmitted, by reader device 404, to proxy device 406. As an example, proxy device 406 is within range of device 402. As an example, the attacker holding proxy device 406 pretends to pay with device 406 to device 402. Device 406 then transmits the message from device 400 to device 402. Thus, device 402 believes that the transaction has been carried out by device 406, while it is, in fact, carried out by device 400 and, for example, without the knowledge of the holder of device 400.

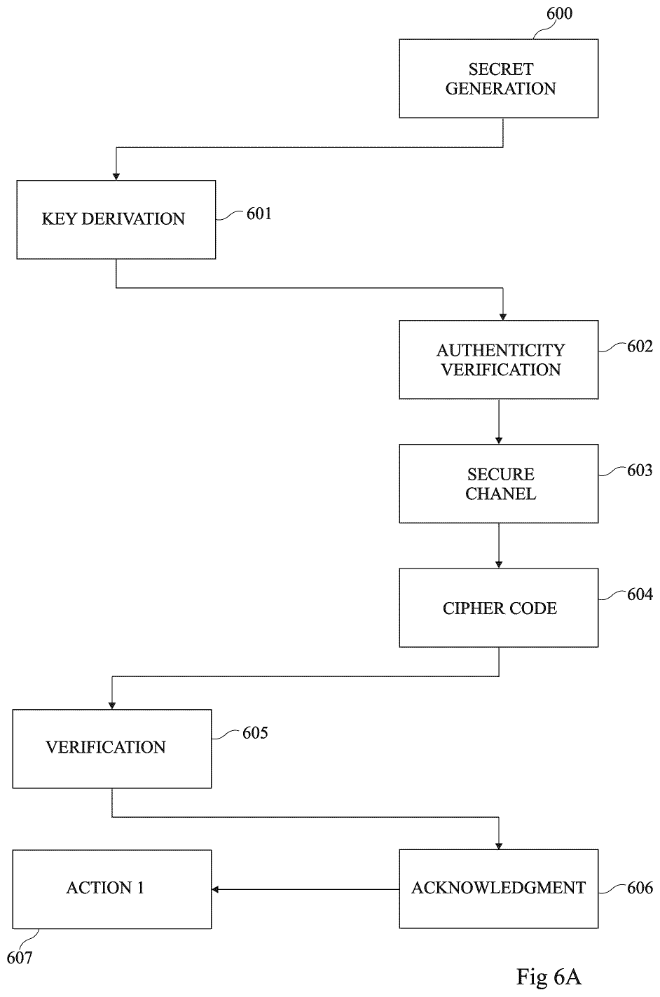

FIG. 5 is a block diagram illustrating a system 500 configured to implement an authentication method, according to an embodiment of the present disclosure. System 500 comprises, for example, a device 502, such as for example a parking terminal, a locker, or a smartphone, comprising an electronic chip 504 configured to perform NFC-type communications. As an example, chip 504 comprises, or is, a secure element.

System 500 further comprises a device 506, such as a for example a smartphone, device 506 comprising an electronic chip 508 configured to perform NFC-type communications. As an example, chip 508 comprises an NFC emulation software brick as described in relation with FIG. 3B.

System 500 is configured to interact with a user 509 (USER). As an example, the user is the holder of device 506.

Chip 504, contained in device 502, for example comprises a processor 510 (CPU) coupled to a non-volatile memory 512 (NVMEM) via a bus 514. According to an embodiment, processor 510 is configured to perform cryptographic operations, such as cryptographic operations on elliptic curves. As an example, memory 512 is contained in a hardware security component, such as a secure element, a trusted platform module, a secure storage element, etc.

According to an embodiment, memory 512 stores the value of at least one secret key, such as for example a secret key linked to the provider of the service implemented by device 502. Memory 512 for example further stores at least one private key associated with device 502, as well as a secret value. Memory 512 further stores, for example, at least one public key, such as for example a public key associated with device 502. As an example, the public key is stored in ciphered form, for example by being signed by the private key. As an example, memory 512 and processor 510 are contained in a secure element of device 502.

Device 502 further comprises, for example, an interface 516 coupled to bus 514. As an example, interface 516 is a keypad, a touch screen, a QR code scanner, etc.

Chip 508 comprises, for example, a processor 518 (CPU) coupled to a non-volatile memory 520 (NVMEM) via a bus 522. According to an embodiment, processor 518 is configured to perform cryptographic operations, such as for example cryptographic operations on elliptic curves.

Chip 508 further comprises an application 524 (APP.). As an example, application 524 is a software application installed in a non-volatile memory of device 506 coupled to bus 522. Application 524 is configured to, when it is executed by processor 518, generate elements, such as for example numerical values and mnemonic or seed phrases. As an example, the seed phrases are word sequences, for example sequences of between 3 and 24 words. Each word in a seed phrase is for example randomly selected from a standard list of words, for example from a list of 2,048 words determined by the BIP39 (Bitcoin Improvement Proposal 39) standard. In another example, application 524 is configured to generate quick response codes (QR codes).

Device 506 further comprises an interface 526 (INTERFACE) enabling user 509 to interact with device 526. As an example, interface 526 is a touch screen, a keypad, etc.

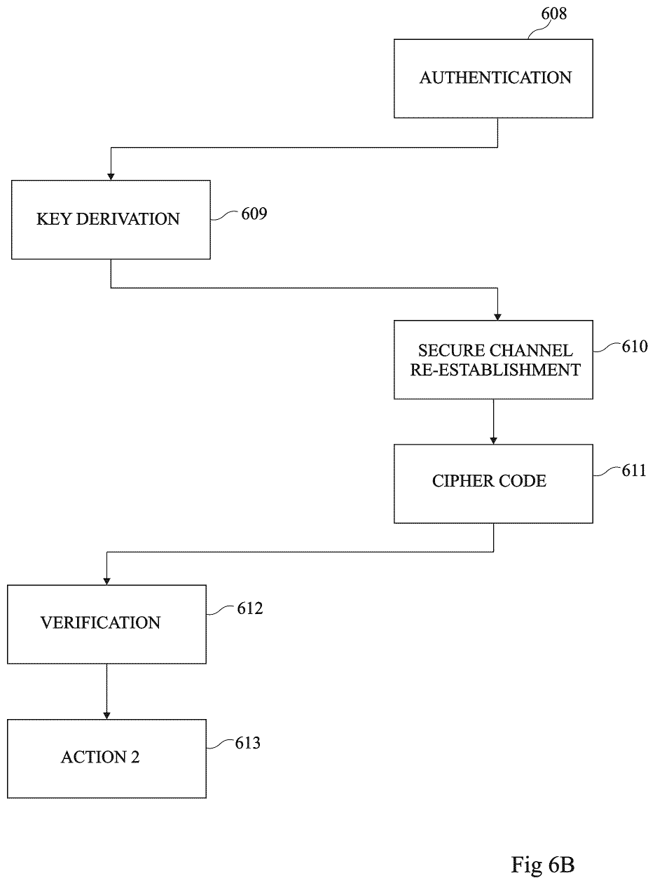

FIG. 6A is a flowchart illustrating steps of an authentication method. In particular, the flowchart of FIG. 6A illustrates steps for the execution of a first action by device 502. As an example, the first action is the locking of a bicycle in a parking terminal, the locking of a locker or, more generally, of a door. In another example, the first action is the unlocking of a bicycle, or of a vehicle, made available to user 509. In another example, the first action is a validation or an authorization, for example to enter a tourist site.

At a step 600 (SECRET GENERATION), user 509 for example launches the execution of application 524 on device 506. As an example, a digital value PIN, such as a personal identification number (PIN), is generated by device 506 during the carrying out of step 600. In another example, a quick response code is generated during the carrying out of step 600. As an example, the generated digital value, or code, is directly accessible by user 509. As an example, value, or code, PIN is displayed on a screen of device 506. According to an embodiment, value, or code, PIN is also stored in memory 520.

During the carrying out of step 600, another element mnemonic is generated during the execution of application 524. As an example, the other element mnemonic is a seed phrase comprising, for example, between 3 and 24 words, for example 12 words. Seed phrase mnemonic generated is, for example, directly stored in memory 520. As an example, the seed phrase is not supplied to user 509.

During the carrying out of step 600, user 509 transmits the value, or code, previously generated by application 524, directly to device 502. As an example, user 509 enters, for example manually, value PIN via the interface. In another example, user 509 scans, via the device 502, the quick response code, for example by presenting device 506 to a reader of device 502.

The fact for user 509 to directly supply device 502 with the value or the code protects system 500 from man-in-the-middle attacks.

At a step 601 (KEY DERIVATION), device 502 uses a private key skₜₑᵣₘᵢₙₐₗ as well as a secret value chaincodeₜₑᵣₘᵢₙₐₗ in combination with the value, or code, PIN provided by user 509, to generate a private key sk_{user/terminal}. As an example, private key sk_{user/terminal} is generated, by device 502, by application of a key derivation function to private key skₜₑᵣₘᵢₙₐₗ, secret value chaincodeₜₑᵣₘᵢₙₐₗ, and value, or code, PIN. As an example, the generation of private key sk_{user/terminal} is securely performed by processor 510.

Private key skₜₑᵣₘᵢₙₐₗ and secret value chaincodeₜₑᵣₘᵢₙₐₗ are values stored in memory 512, for example, during the manufacturing, or during the putting into service, of device 502. These values are, for example, values specific to device 502. In the example where device 502 is a parking terminal, a locker, etc., each terminal and/or locker comprises a private key and a secret value different from those stored in the other similar devices.

Device 502 further comprises, for example, a public key pkₜₑᵣₘᵢₙₐₗ, as well as a private key skₘₐₛₜₑᵣ associated with the holder of device 502. Keys pkₜₑᵣₘᵢₙₐₗ and skₘₐₛₜₑᵣ are securely stored in memory 512. In another example, public key pkₜₑᵣₘᵢₙₐₗ takes the form of an electronic certificate.

A public key pkₘₐₛₜₑᵣ, associated with secret key skₘₐₛₜₑᵣ, is, for example, further stored in memory 520 of device 506. As an example, public key pkₘₐₛₜₑᵣ is stored in memory 520 on installation of application 524.

At step 601, the device 506 further generates, for example securely, a public key pk_{user/terminal}. As an example, public key pk_{user/borne} is the result of the multiplication of a point of an elliptic curve by the value of private key sk_{user/terminal}. As an example, the point of the elliptic curve used is the generating point of said elliptic curve. The elliptic curve on which the calculation is performed is, for example, defined upstream and is an elliptic curve adapted to the implementation of key exchanges according to a Diffie-Hellman protocol.

Step 601 further comprises the electronic signature of public key pkₜₑᵣₘᵢₙₐₗ for example by private key skₘₐₛₜₑᵣ. Step 601 further comprises the electronic signature of public key pk_{user/terminal}, for example by private key skₜₑᵣₘᵢₙₐₗ.

Step 601 further comprises, for example, the transmission of the signed keys pkₜₑᵣₘᵢₙₐₗ and pk_{user/terminal} to device 506. As an example, the transmission of the signed keys is performed by NFC communication between devices 502 and 506.

At a step 602 (AUTHENTICITY VERIFICATION), device 506, via the execution of application 524, verifies the authenticity of device 502. The verification of the authenticity of device 502 comprises, for example, the verification of the signature of public key pkₜₑᵣₘᵢₙₐₗ. The verification is for example carried out based on the key pkₘₐₛₜₑᵣ stored, for example, in memory 520. In the case where this verification fails, the method ends in failure and the communication between devices 502 and 506 is interrupted. As an example, when the process ends in failure, value PIN value is deleted from device 502 and keys pkₜₑᵣₘᵢₙₐₗ and pk_{user/terminal} are deleted from device 506. As an example, the elements generated during steps 600 and 601, such as seed phrase mnemonic and keys sk_{user/terminal} and pk_{user/terminal}, are deleted from the memories of devices 502 and 506.

When the verification of the digital signature of public key pkₜₑᵣₘᵢₙₐₗ succeeds, step 602 continues with the verification of the signature of public key pk_{user/terminal}. As an example, as a result of the verification of the digital signature of key pkₜₑᵣₘᵢₙₐₗ, the value of key pkₜₑᵣₘᵢₙₐₗ is known by device 506. The verification of key pk_{user/terminal} is for example carried out via the execution of application 524 and based on key pkₜₑᵣₘᵢₙₐₗ. In the case where the verification of the signature of key pk_{user/terminal} fails, the method ends in failure. When the verification of key pk_{user/terminal} succeeds, public key pkₜₑᵣₘᵢₙₐₗ, seed phrase mnemonic, and value, or code, PIN are stored in memory 520. For example, seed phrase mnemonic and value, or code, PIN are stored in memory 520 in association with, and/or for example indexed by public key pkₜₑᵣₘᵢₙₐₗ.

As an example, the NFC communication between devices 502 and 506, in particular the transmission of the signed keys pkₜₑᵣₘᵢₙₐₗ and pk_{user/terminal}, is carried out in a metal niche, for example made of aluminum, in order to thwart a relay attack. As an example, the metal niche is adjacent to, or forms part of, device 502. As an example, keys pkₜₑᵣₘᵢₙₐₗ and pk_{user/terminal} are displayed, for example, in the form of quick response codes, on interface 516 and are scanned by user 509.

At a step 603 (SECURE CHANNEL), a secret key ephemeralkey is generated by device 506 to create a secure channel with device 502.

According to an embodiment, via the execution of application 524, seed phrase mnemonic is used to generate a value masterkey. As an example, value masterkey is a 64-byte value. According to an embodiment, the bytes, for example the 64 bytes, of value masterkey are divided into at least 5 parts. For example, a first 32-byte part forms a private key skphone/borne and the other 32 bytes are used to define four authenticator values authN1, authN2, authN3, and authN4, each of, for example, 8 bytes. Thus, value masterkey, generated from the seed phrase, is a concatenation of private key sk_{phone/terminal} and of authentication values authN1 to authN4. Although the example of a 64-bit value, divided into a 32-byte key and 4 8-byte identifiers, is provided, other sizes and other divisions may of course be envisaged. As an example, bytes 0 to 31 of value masterkey define private key SK_{phone/terminal}; bytes 32 to 39 define authentication value authN1; bytes 40 to 47 define authentication value authN2; bytes 48 to 55 define authentication value authN3; and bytes 56 to 63 define authentication value authN4.

According to an embodiment, secret key ephemeralkey is generated by device 506, during the execution of application 524, based on private key sk_{phone/terminal} and on public key pk_{user/terminal}. As an example, secret key ephemeralkey is obtained by multiplication on the elliptic curve of the point defined by public key pk_{user/terminal} by the scalar determined by the value of private key sk_{user/terminal}. As an example, the multiplication of key pk_{user/terimnal} by key sk_{user/phone} results in a point on the elliptic curve. The obtained point is thus defined by two coordinates (ephemeralkey(x), ephemeralkey(y)). As an example, secret key ephemeralkey is equal to coordinate ephemeralkey(x). It is, of course, quite possible for secret key ephemeralkey to be equal to coordinate ephemeralkey(y). Secret key ephemeralkey is then used to cipher communications transmitted by device 506 to device 502.

A public key pk_{phone/terminal} is further generated during the execution of application 524. As an example, public key pk_{phone/terminal} is a point on the elliptic curve comprising two coordinates, the point originating from the result of the multiplication of point G, generator of the considered elliptic curve, by the scalar defined by private key sk_{phone/terminal}.

At a step 604 (CIPHER CODE), a secret code is determined. As an example, user 509 has no control over the selection of the secret code. As an example, the secret code is determined as forming part of the generated value masterkey. As an example, the secret code is equal to authentication value authN1. Other possibilities may of course be envisaged. Indeed, the secret code may also be equal to a value from among values authN2, authN3, or authN4.

As an example, via the execution of application 524, the secret code is concatenated with one of the other authentication values. As an example, authentication value authN1 is concatenated with identification value authN2. The concatenation of the secret code with the identification value, for example authN2, is then ciphered by secret key ephemeralkey, resulting in a value cipher_codelock.

A message comprising value cipher_codelock and the two coordinates of public key pk_{phone/terminal} is then transmitted, by NFC communication, to device 506.

As an example, the transmitted message further comprises a message authentication code (MAC), or a hash-based message authentication code (HMAC), ciphered with the unused coordinate of the point calculated for the generation of the secret key. As an example, the MAC, or the HMAC, is generated based on coordinate ephemeralkey(y). As an example, the MAC or the HMAC is a cryptographic hash, and its generation comprises the calculation of a checksum.

At a step 605 (VERIFICATION), device 502 generates secret key ephemeralkey. The generation of secret key ephemeralkey is performed, for example, based on the public key pk_{phone/terminal} received during the carrying out of step 604. Secret key ephemeralkey is, for example, a coordinate of point (ephemeralkey(x), ephemeralkey(y)), for example coordinate ephemeralkey(x), obtained by multiplication on the elliptic curve of the point defined by public key pk_{phone/terminal} by the scalar defined by the value of private key sk_{user/terminal}.

As an example, the MAC, or HMAC, code generated and received during the carrying out of step 604 is for example verified by using the other coordinate, for example the coordinate ephemeralkey(y) generated by device 502.

As an example, if the verification of the MAC code or of the HMAC code fails, then the method ends in failure.

When the verification of the MAC code, or of the HMAC succeeds, the ciphered value cipher_codelock is stored in memory 512 of device 502.

At a step 606 (ACKNOWLEDGMENT), device 506 ciphers a value, for example value PIN, or a value originating from the quick response code. As an example, the ciphering is performed based on secret key ephemeralkey.

As an example, the ciphering is performed on value PIN, or on a value originating from the quick response code, concatenated with another value. As an example, this other value corresponds to the 8 most significant bytes of private key sk_{user/terminal}. More generally, the other value is a value known by devices 502 and 506.

The value ciphered during the carrying out of step 606 is then transmitted, by NFC communication, to device 506. Device 506 is then configured, via the execution of application 524, to decipher the received ciphered value. As an example, the deciphering is performed based on the application of a symmetrical ciphering algorithm using secret key ephemeralkey. Device 506 is then configured to compare the deciphered value with value PIN or with the quick response code. As an example, the verification is carried out by comparison of the first bytes, for example the bytes preceding the last 8 bytes of the deciphered value, with value PIN, or the quick response code.

In an example, device 506 is further configured to communicate to user 509 the value, or the first bytes of the deciphered value. As an example, the communication with the user is performed by display on interface 526. User 509 then verifies whether the communicated value corresponds, for example, to his/her code PIN generated during the carrying out of step 600. If the values do not match, user 509 indicates, via interface 526 for example, that the values do not match, and the process ends in failure. If the values match, user 509 indicates, for example via interface 526, that the values match, thus validating the authentication between the two devices 502 and 506.

Device 506 is then configured, via the execution of application 524 and when the values match, to transmit an acknowledgment value ACK ciphered by secret key ephemeralkey. As an example, acknowledgment value ACK is concatenated with one of the authentication values, for example with value authN3, before being ciphered by secret key ephemeralkey.

The ciphered, for example concatenated, acknowledgment value is then transmitted by NFC communication to device 502.

Device 502 is then configured to decipher, via secret key ephemeralkey, the value received during the carrying out of step 606 and to compare it, or to compare the first bytes corresponding to the number of bytes forming acknowledgment value ACK, of the deciphered value, with acknowledgment value ACK. As an example, acknowledgment value ACK has been previously stored in memory 512, for example during the manufacturing, or during the putting into service, of device 502.

As an example, in the case where the deciphered value ACK does not match the stored value, the method ends in failure. When the deciphered value ACK does match the stored value, the method continues at a step 607 (ACTION 1). Step 607 comprises the execution of an action, such as the locking, or the unlocking, of the bicycle or the vehicle of user 509, the locking of the locker door, the validation of the entry of user 509 in a tourist site etc., by device 502.

As an example, after the carrying out of step 607, secret key ephemeralkey is not stored in any memory of devices 502 and 506.

As a result of the carrying out of step 607, device 506 stores the value or code, PIN, seed phrase mnemonic, and the public key pk_{user/terminal}. Device 502 keeps in memory the ciphered value cipher_codelock. As an example, device 502 keeps in memory the ciphered value cipher_codelock deciphered via secret key ephemeralkey. As an example, the other values, transmitted and/or generated by one or the other of device 502 or 506, are deleted from memories 512 and 520.

FIG. 6B is a flowchart illustrating steps of an authentication method, according to an embodiment of the present disclosure.

As an example, the steps described in relation with FIG. 6B are carried out when the user retrieves his/her bicycle or vehicle from the parking terminal, or returns the vehicle which was made available to him/her, or retrieves belongings placed in the locker, or also when user 509 leaves the tourist site that he/she was visiting etc.

A step 608 (AUTHENTICATION) is for example carried out on the initiative of user 509. As an example, user 509 comes, with device 506, before device 502. As an example, through the execution of application 524, device 506 transmits a request by NFC communication to device 502.

As an example, device 502 is configured to expose the public key pkₜₑᵣₘᵢₙₐₗ signed by private key skₘₐₛₜₑᵣ to device 506. As an example, device 502 exposes a digital certificate comprising the value of public key pkₜₑᵣₘᵢₙₐₗ signed by the value of key skₘₐₛₜₑᵣ. As an example, the signed public key pkₜₑᵣₘᵢₙₐₗ, or the certificate, is transmitted by NFC communication. In another example, the value is for example displayed on interface 516, for example in the form of a quick response code, and user 509 presents device 506 to scan the code.

Device 506, via the execution of application 524, is then configured to verify the authenticity of device 502 by using the public key pkₘₐₛₜₑᵣ stored in memory 520, for example, on installation of application 524.

In the case where the verification of the authenticity of device 506 fails, the methods ends in failure.

When the authenticity verification is successful, a request for the carrying out of the second action is transmitted by device 506 to device 502.

As an example, the request comprises the transmission of the PIN value, or code, to device 502. As an example, the value is transmitted in clear text by NFC communication.

At a step 609 (KEY DERIVATION), device 502 generates again private key sk_{user/terminal} based on the value, or code, PIN received at step 608, on private key skₜₑᵣₘᵢₙₐₗ, and on secret value chaincodeₜₑᵣₘᵢₙₐₗ. As an example, private key sk_{user/terminal}is obtained by application of a key derivation function to value, or code, PIN, private key sktₑᵣₘᵢₙₐₗ, and secret value chaincodeₜₑᵣₘᵢₙₐₗ.

The deterministically regenerated private key sk_{user/terminal} is then, for example, signed by private key skₜₑᵣₘᵢₙₐₗ. The signed private key sk_{user/terminal} is then transmitted, by NFC communication, to device 506.

At a step 610 (SECURE CHANNEL RE-ESTABLISHMENT), device 506, via the execution of application 524, regenerates value masterkey from the seed phrase mnemonic kept in memory. Device 506 further regenerates secret key ephemeralkey and public key pk_{phone/terminal}. The carrying out of step 610 is identical to the carrying out of step 603. As an example, a MAC code, or an HMAC code, is further generated from coordinate ephemeralkey(y) or epehemeralkey(x) if relevant.

At a step 611 (CIPHER CODE), device 506 generates a new secret code codeunlock. The new secret code is equal to the secret code codelock generated during the carrying out of step 604. In other words, the new secret code codeunlock is equal to the authentication value authN1 regenerated during the carrying out of step 610. The new secret code codeunlock is then concatenated with a value different from that concatenated with the value of code codelock during the carrying out of step 604. As an example, the new code code_unlock is concatenated with authentication value authN4. The concatenation of the two values is then ciphered via secret key ephemeralkey, resulting in a ciphered value cipher_codeunlock. Thus, although the two secret codes codelock and codeunlock are identical, the ciphered values cipher_codelock and cipher_codeunlock are different.

A message comprising ciphered code cipher_codeunlock, public key pk_{phone/terminal}, regenerated during the carrying out of step 610, as well as the MAC or HMAC code generated, for example based on coordinate ephemeralkey(y) is supplied to device 502.

At a step 612 (VERIFICATION), device 502 estimates, for example, the time elapsed between the transmission of the message and its receipt. Device 502 is then configured to compare the estimated time with a reference time period. As an example, the reference time period is a time period shorter than 1 second, for example in the order of several milliseconds. If the estimated time is longer than the reference time period, the method ends in failure. In the case where the estimated time is much shorter than the reference time period, device 502 regenerates secret key ephemeralkey. The generation of secret key ephemeralkey is performed identically to the generation carried out at step 605. Device 502 then for example verifies the integrity of the received MAC or HMAC code, for example, by deciphering it by means of coordinate ephemeralkey(y) or ephemeralkey(x) if relevant, also regenerated during the calculation of secret key ephemeralkey. If the integrity of the MAC or HMAC code is not verified, the method ends in failure. If the MAC or HMAC code is effectively intact, device 502 deciphers the ciphered code cipher_codeunlock. Device 502 further deciphers the ciphered code cipher_codelock kept in memory after the carrying out of step 607.

Device 502 is then configured to compare the first bytes, for example the number of bytes corresponding to the size of the authentication values, for example the 8 first bytes of the deciphered codes cipher_codeunlock and cipher_codelock. If the two compared elements, normally equal to authentication value authN1, do not match, the method ends in failure. If the two compared elements match, and are thus both equal to value authN1, device 502 compares the remaining bytes, for example the last 8 bytes, of the deciphered codes cipher_codeunlock and cipher_codelock. If the remaining bytes of the deciphered codes cipher_codeunlock and cipher_codelock are equal, the method ends in failure.

If the remaining bytes of the deciphered codes cipher_codeunlock and cipher_codelock differ, the method continues at a step 613 (ACTION 2). Indeed, in order for the method not to end in failure, the last bytes of the deciphered codes cipher_codeunlock and cipher_codelock have to differ, some being for example equal to value authN2 and the others to value authN4. Indeed, if the last bytes of the deciphered codes cipher_codeunlock and cipher_codelock are equal, this means that a replay attack is possibly occurring.

The implementation of step 613 consists, for example, in the execution of the second action.

As an example, after the carrying out of step 614, value, or code, PIN, seed phrase mnemonic, and public key pk_{user/terminal}, as well as all the other values and elements generated during the carrying out of steps 608 to 613, are deleted from memory 520. Similarly, the ciphered code cipher_codelock stored in memory 512 as a result of step 607 is deleted from memory 512, as well as all other values generated and received during the carrying out of steps 608 to 613. In other words, as a result of the carrying out of step 614, keys skₘₐₛₜₑᵣ, Skₜₑᵣₘᵢₙₐₗ, and value chaincodeₜₑᵣₘᵢₙₐₗ are stored in memory 512 and key pkₘₐₛₜₑᵣ is stored in memory 520.

As an example, all the operations performed by device 502 are carried out in a secure manner, for example in a secure hardware element of device 502.

The steps described in relation with FIGS. 6A and 6B may be carried out in parallel between device 506 and a plurality of devices similar to device 502. In this case, the values, or codes, as well as the seed phrases generated by device 506, differ for each device similar to device 502. Thus, all other values and keys generated during the carrying out of the steps described in relation with FIGS. 6A and 6B differ between each device similar to device 502.

As an example, for example when the first action consists in the unlocking of a vehicle from a parking terminal and the second action consists in the locking of the vehicle in a parking terminal, the device 502 with which the first action is executed may differ from the device 502 with which the second action is executed. In this case, the use of key skₜₑᵣₘᵢₙₐₗ is replaced by the use of key skₘₐₛₜₑᵣ and only a self-signed certificate is exposed during the carrying out of step 601. In this case, public key pkₜₑᵣₘᵢₙₐₗ does not differ from one device 502 to the other.

In certain cases, another user of a device 506 distant from device 502 communicates public key pkₜₑᵣₘᵢₙₐₗ, value, or code, PIN, and phrase mnemonic to another user having a device similar to the device 506 within range of device 502. As an example, the steps described in relation with FIG. 6A are carried out with a user different from that present for the carrying out of the steps described in relation with FIG. 6B. This example for example occurs when user 509 wishes to lend his/her vehicle, that he/she has parked in a parking terminal, to a third party.

An advantage of the described embodiments is that they allow for a communication robust to most known cyberattacks.

Another advantage of the described embodiments is that their carrying out is performed with no connection to any network. Thus, the implementation of the described embodiments is also possible in a white zone. In particular, NFC communication does not require a PKI (Public Key Infrastructure).

An advantage of the described embodiments is that the number of elements kept in memory of devices 502 and 506 is limited.

Various embodiments and variants have been described. Those skilled in the art will understand that certain features of these various embodiments and variants may be combined, and other variants will occur to those skilled in the art. The values used for the concatenations are given as an example and are not limiting.

Finally, the practical implementation of the described embodiments and variants is within the abilities of those skilled in the art based on the functional indications given hereabove. In particular, with regard to the presence and the use of a hardware security component, such as a secure clement, in device 506. It may of course be envisaged for the calculations performed by device 506 to be performed in a secure environment.

1. A method of authentication between a first device and a second device, the method comprising:
the generation, by the first device, of a first element and of a second element, and their storage into a memory of the first device;
the supplying of the first element, via a user of the first device, to the second device;
the generation, by the second device, based on the first element and by application of a Diffie-Hellman protocol, of a first public key;
the supplying of the first public key to the first device and the storage of the first public key, in association with the first and second elements, into a memory of the first device;
the generation, by the first device, of a session key, based on the second element and on the first public key, by application of a Diffie-Hellman protocol on an elliptic curve;
the generation, by the first device, of a first code, based on the second element, and its ciphering by the session key;
the generation, by the first device, of a second public key;
the supplying, by a near-field communication, of the first ciphered code and of the second public key to the second device;
the generation, by the second device, of the session key based on the first element and on the second public key, and the deciphering of the ciphered first code by means of the session key;
the storage, in a memory of the second device, of the deciphered first code;
the control, by the second device, of a first actuator as a result of an authentication of the second device, or of a third device, by the first device and based on the first public key.

2. The method of authentication according to claim 1, further comprising:
the generation, by the first device, of a second code, based on the second element, and its ciphering it by the session key and the supplying, by near-field communication, of the ciphered second code to the second, or to the third, device;
the deciphering, by the second, or the third, device, of the ciphered second code and the comparison of the deciphered second code with the deciphered first code;
based on the comparison between the deciphered first and second codes, the control, by the second device or by the third device, of the first or of a second actuator.

3. The method of authentication to claim 2, wherein the control of the first actuator causes an action of locking, or of unlocking, of the second device and the control of the second actuator causes an action of unlocking, or of locking, of the second, or of the third, device.

4. The method of authentication according to claim 1, wherein the first public key is supplied, by the second device, to the first device via a non-secure near-field communication.

5. The method of authentication according to claim 1, wherein the first element is a digital code and wherein the provision of the first element to the second device, via the user, consists of the entering, by the user, of the digital code on a keypad of the second device.

6. The method of authentication according to claim 1, wherein the first element is a quick response code and wherein the supply of the first element to the second device, via the user consists of the presentation of the quick response code to a quick response code reader of the second device.

7. The method of authentication according to claim 1, wherein the second element is a random value comprising a number N of words comprised in a standard dictionary of entropy-coding words, for example the BitCoin improvement proposal 39 wordlist, N being an integer in the range from 3 to 24.

8. The method of authentication according claim 1, wherein the session key is deleted from the first and second devices as a result of the execution of the first action, and wherein the session key is generated again, by the first device and then by the second, or the third, device, as a result of the authentication of the second, or of the third, device by the first device.

9. The method of authentication according to claim 1, further comprising, prior to the generation, by the first device, of the session key, the authentication of the second device, by the first device and based on the first public key and based on a master key.

10. The method of authentication according to claim 1, further comprising, prior to the carrying out of the first action:
the ciphering, by the second device, of the first element, and the supplying of the ciphered first element to the first device;
the deciphering, by the first device, of the first ciphered element and the comparison between the deciphered first element and the first element; and
if the deciphered first element and the first element do not match, the stopping of the method.

11. The method of authentication according to claim 1, further comprising as a result of the generation of the first code, the supplying of a message authentication code to the second device.

12. The method of authentication according to claim 11, wherein the message authentication code is one of the coordinates, on the elliptic curve, of the session key.

13. The method of authentication according to claim 2, further comprising, as a result of the supply of the first deciphered code and/or of the second ciphered code:
the estimating, by the second, or the third, device, of the time elapsed between the sending, by the first device, of the ciphered code and the receipt, by the second device, of the ciphered code;
the comparison, by the second, or the third, device, of the estimated elapsed time with a threshold value; and
if the estimated elapsed time is greater than or equal to the threshold value, the stopping of the method.

14. The method of authentication according to claim 2 wherein the first code is a concatenation of a first part of a value generated based on the second element with a second part of the value and wherein the second code is a concatenation of the first part of the value with a third part of the value.

15. A system comprising a first and a second devices configured to carry out a method of authentication between a first device and a second device, the method comprising:
the generation, by the first device, of a first element and of a second element, and their storage into a memory of the first device;
the supplying of the first element, via a user of the first device, to the second device; the generation, by the second device, based on the first element and by application of a Diffie-Hellman protocol, of a first public key;
the supplying of the first public key to the first device and the storage of the first public key, in association with the first and second elements, into a memory of the first device;
the generation, by the first device, of a session key, based on the second element and on the first public key, by application of a Diffie-Hellman protocol on an elliptic curve;
the generation, by the first device, of a first code, based on the second element, and its ciphering by the session key;
the generation, by the first device, of a second public key;
the supplying, by a near-field communication, of the first ciphered code and of the second public key to the second device;
the generation, by the second device, of the session key based on the first element and on the second public key, and the deciphering of the ciphered first code by means of the session key;
the storage, in a memory of the second device, of the deciphered first code;
the control, by the second device, of a first actuator as a result of an authentication of the second device, or of a third device, by the first device and based on the first public key.

16. The system according to claim 15, wherein the first device is a smartphone.
